(19) United States
(12) Patent Application Publication
(10) Pub. No.: US 2025/0311824 A1
(43) Pub. Date: Oct. 9, 2025

(54) SECURITY DEVICES

(71) Applicant: Zeal Innovation Ltd, Swansea (GB)

(72) Inventor: Neil Anthony BARRON, Swansea (GB)

(21) Appl. No.: 18/867,600

(22) PCT Filed: May 19, 2023
(86) PCT No.: PCT/GB2023/051323

§ 371 Date: Nov. 20, 2024

(30) Foreign Application Priority Data
May 20, 2022 (GB) 2207442.1

(51) Int. Cl. A45C 13/20; D07B 1/06

(52) U.S. Cl. CPC A45C 13/20; D07B 1/068; D07B 2201/2011; D07B 2201/2083

(57) ABSTRACT

A security device includes a flexible rope of diameter in the range 10-25 mm comprising helically wound strands with collars clamping the rope at spaced locations therealong. The spacing between the collars is less than or substantially equal to the rope diameter, and each collar has a wall thickness in the range 5-15% of the rope diameter. The axial length of each collar is normally no greater than the rope diameter. The collars engage the rope with sufficient pressure to prevent substantial relative lateral movement of the strands at each location.

This invention relates to security devices, and has particular application in security devices in which two ends of an elongate element must be held together. Such devices can be used for securing baggage and light vehicles in the manner described in various Patent publications including International Specification Nos. WO2010/103327 and WO2015/087067; and U.S. Pat. Nos. 5,706,679 and 6,510,717, the disclosures whereof are hereby incorporated by reference. The present invention focuses on such an elongate element in the form of a metal rope.

Metal ropes or cables comprising helically wound strands are very strong, but can be broken relatively easily using cable cutters which unravel the strands enabling in effect, the strand to be cut individually. In order to stabilise the strands and prevent such unravelling by cable cutters or boltcroppers for example, a security device according to the present invention includes a flexible metal rope of diameter in the range 10-25 mm comprising helically wound strands with collars clamping the rope at spaced locations therealong. The spacing between the collars is less than or substantially equal to the rope diameter, and each collar has a wall thickness in the range 5-15% of the rope diameter. The axial length of each collar is normally no greater than the rope diameter. The collars engage the rope with sufficient pressure to prevent substantial relative lateral movement of the strands at each location. This pressure is normally in the range 1 to 8 tonnes; normally at least 4 tonnes, and preferably 5 to 8 tonnes. When installed with the rope ends secured such that the rope as a whole cannot be untwisted, the collars effectively lock the paths of the strands between them. Whilst substantial relative lateral movement of the strands is prevented, it will be understood that some longitudinal movement is possible to allow the rope to be bent. However, the amount of permitted bending will be limited, and determined by the pressure applied by the collars.

Typically, each collar is a metal band secured around the rope. It may take the form of a metal strip with its ends drawn together to stretch it around the rope, or a closed loop with at least one lateral extension crimped to stretch it around the rope. In a preferred embodiment, each collar is a metal annulus swaged to engage the rope with sufficient pressure. Swaging can result in the external cross section of the respective collar being polygonal, and a preferred swaging technique results in this cross section being hexagonal. Collars can also be formed on the rope by locating complementary tube sections around it and swaging the sections. The sections are in this way pressure welded. In a preferred swaging process complementary tube sections of substantially semicircular cross section are used. Swaging in the making of a rope for use in devices of the invention can reduce the rope diameter by an amount in the range 6-8%.

The metal rope used in devices of the invention comprises metal strands wound around an helically wound core. The strands themselves can comprise helically wound wires. The rope is preferably a compacted wire rope. As noted above the rope diameter is in the range 10 to 25 mm, but preferred rope have a diameter in the range 12 to 22 mm. The metal used is normally high tensile steel. However, for some applications different materials, even non-metals can be used for either or both of the rope and collars, particularly if the primary objective is to prevent unravelling or untwisting of the rope.

In some embodiments of the invention tubular elements can be installed between the collars. The elements can be shaped to receive the collars with the juxtaposed surfaces of both the collars and the element ends being curved to allow restricted bending of the rope adjacent each collar. The elements themselves can be compressible to accommodate such bending.

Ropes used in the invention can be coupled side by side with each collar or selected collars being common to adjacent ropes. Such an arrangement creates a strap comprising two or more ropes that can bend only in a plane perpendicular to the plane containing the ropes. A collar may be common to more than two ropes, and using selected collars, those common to two or more ropes distributed across the strap.

A security device according to the invention will provide for preventing or at least limiting rotation of one end of the rope relative to the other to avoid untwisting of the rope strands. Typically it will have complementary locking units at respective ends of the rope. To prevent untwisting of the rope locking units will be mounted non-rotatably on the rope ends and adapted to engage in a manner that prevents relative rotation therebetween.

The invention will now be described by way of example and with reference to the accompanying schematic drawings wherein:

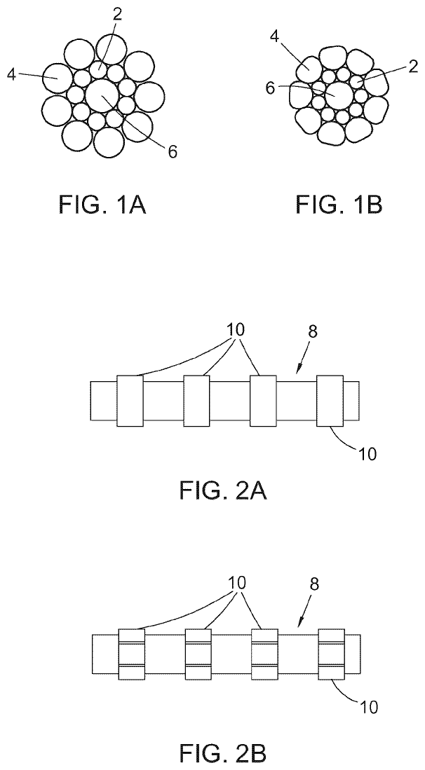

FIGS. 1A and 1B show cross sections of standard and compacted metal rope;

FIGS. 2A and 2B shows a length of rope fitted with collars for use in security devices according to the invention;

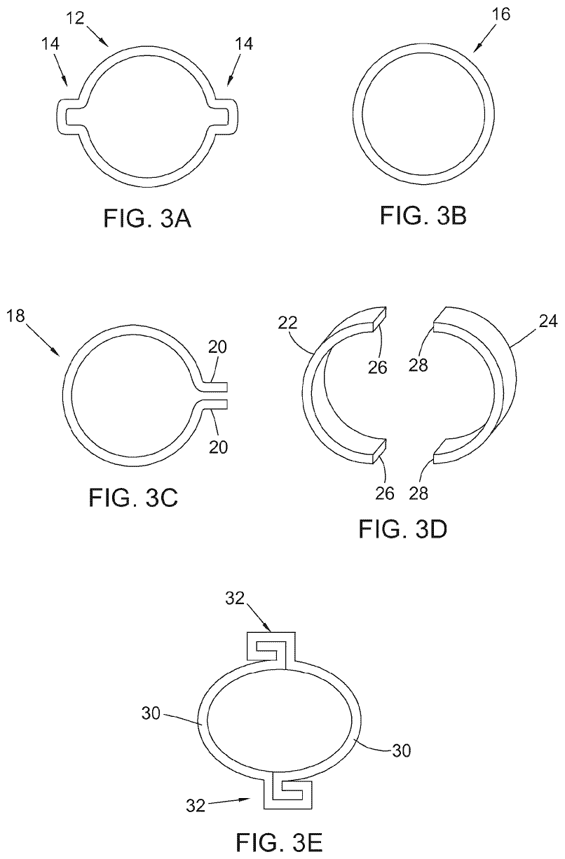

FIGS. 3A, 3B, 3C, 3D and 3E illustrate cross sections of different collars;

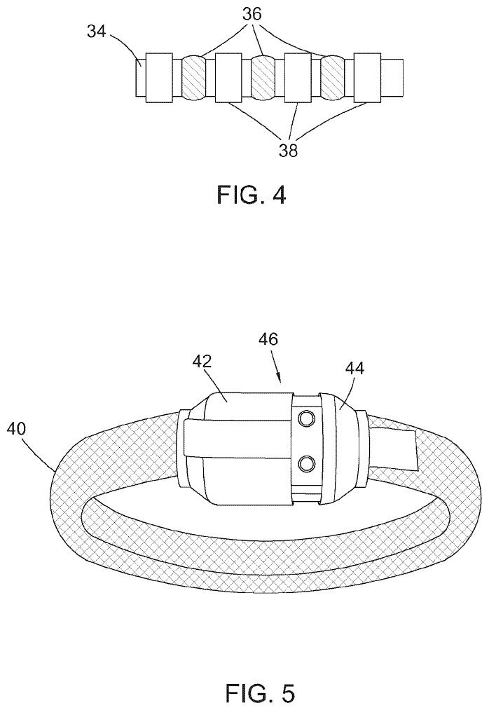

FIG. 4 shows a length of rope for use in devices according to the invention with tubular elements between collars; and

FIG. 5 is a perspective view of a security device according to the invention.

The rope cross section shown in FIG. 1A comprises metal strands 2 and 4 helically wound in two layers around a metallic core 6, which may itself comprise helically wound strands. The strands 2 and 4 may also comprise helically wound wires. FIG. 1B shows a similar cross section, but of a compacted wire rope. The preferred material used for the strands and wires is high tensile steel. Compacting wire rope reduces its diameter by 10-20%. Thus, a rope of initial diameter around 15 mm can be compacted to around 13.5 mm.

FIG. 2A shows a length of metal rope 8 with collars 10 in the form of simple annuli spaced therealong, each in the form of a metal band, prior to being swaged to clamp the rope. The spacing between the collars 10 along the rope is less than or substantially equal to the rope diameter. In the example shown the rope diameter and the spacing between the collars is substantially the same, at around 15 mm. The width or axial length of each collar is about 10 mm. FIG. 2B shows the rope of FIG. 2A after swaging the collars around the rope. This swaging reduces the rope diameter by 5-10%, normally 6-8%. As can be seen, swaging has altered the external cross section of the collars which is shown as hexagonal. When the rope is installed as part of a locked security device and wholesale rotation or untwisting of the rope is prevented, the collars prevent unravelling of the strands and, when an attempt is made to break the rope with a conventional cable cutter or boltcropper, prevents the strands from spreading.

As a consequence the rope remains intact and whilst it may eventually fail, the rope will have slowed the process to such an extent to discourage the attempt.

The collar 12 shown in FIG. 3A is a closed band with extensions 14 on opposite sides. When fitted round the rope the extensions 14 are crimped to create a hoop stress in the band which compresses the band against the surface of the rope. The wall thickness of the band will depend upon the material used, but is typically around 2 mm.

The collar 16 shown in FIG. 3B is a solid metal band. When fitted on the rope it is swaged to compress it and clamp the rope as described above with reference to FIG. 1. Its wall thickness before swaging will be around 2 mm. The collar 18 in FIG. 3C is a length of metal strip with tags 20 at either end. When fitted around the rope the tags are brought together and fixed, for example by welding to generate a hoop stress which compresses the band against the rope surface. The collar shown in FIG. 3D is in the form of two matching or complementary tubular parts 22 and 24. When swaged together the engaging or abutting faces 26,28 bond or pressure weld to sustain the requisite pressure on the rope. Whatever form of collar is used the resulting inward pressure on the rope is in the range 5 to 8 tonnes. The collar in FIG. 3E has two matching halves 30 which interlink as shown where they can be crimped as indicated at 32. The halves 30 can be brought together around the rope to interlink, and after crimping may be subject to swaging to achieve the desired inward pressure on the rope.

The rope 34 in FIG. 4 is shown with tubular elements 36 around it between adjacent collars 38. The elements 36 are not fixed or secured on the rope and can move therealong between adjacent collars. Each element 36 is a single band similar to that shown in FIG. 3B, but has a curved outer surface. Adjacent collars 38 have matching annular recesses (not shown) in their juxtaposed ends that receive the end on element 36 when brought together. In preferred embodiments the elements are compressible, and substantially fill the spaces 29 between the collars such that the collars and elements also serve as a sleeve for the rope as a whole.

FIG. 5 shows a security device in the form of a lockable ring suitable for locking a bicycle or motorcycle. The device has a rope of the kind described above in a protective sleeve 40 (in addition to the collars and optional tubular elements). A locking unit 42, 44 is mounted on each end of the rope to be non-rotatable relative thereto, and are selectively held in a mechanism 46, also in a manner which prevents their relative rotation.

1. A security device including a flexible metal rope of diameter in the range 10-25 mm comprising helically wound strands with collars clamping the rope at spaced locations therealong, the spacing being no greater than the rope diameter, each collar having a wall thickness in the range 5-15% of the rope diameter and engaging the rope with sufficient pressure to prevent substantial relative lateral movement of the strands at each location.

2. The security device according to claim 1, wherein each collar is a metal band secured around the rope.

3. The security device according to claim 2, wherein each collar is swaged to engage the rope with sufficient pressure.

4. The security device according to claim 3, wherein the external cross section of each collar is polygonal.

5. The security device according to claim 2, wherein each metal band forms a closed loop with at least one lateral extension crimped to stretch it around the rope.

6. The security device according to claim 2, wherein each metal band is a metal strip with its ends drawn together to stretch it around the rope.

7. The security device according to claim 1, wherein the collars engage the rope with a pressure in the range 5 to 8 tonnes.

8. The security device according to claim 1, wherein the rope is compacted wire rope.

9. The security device according to claim 1, wherein the length of each collar is no greater than the rope diameter.

10. The security device according to claim 1, wherein the rope strands are wound around an a helically wound core.

11. The security device according to claim 1, comprising tubular elements around the rope between the collars.

12. The security device according to claim 11, wherein the element ends are shaped to receive the collars with both the collars and the element ends being curved to allow restricted bending of the rope adjacent each collar.

13. The security device according to claim 11, wherein the elements are compressible.

14. The security device according to claim 1, wherein the rope is enclosed in a sleeve.

15. The security device according to claim 14, wherein the sleeve comprises individual elements closely spaced along the rope.

16. The device according to claim 1, wherein complementary locking units are coupled to respective ends of the rope.

17. The device according to claim 16, wherein the locking units are mounted on the rope ends and non-rotatable relative thereto and adapted to engage in a manner that prevents relative rotation therebetween.

18. A method of making a metal rope for use in a device according to claim 1, wherein metal collars are located on the rope and swaged to engage the rope strands with said sufficient pressure

19. The method according to claim 18, wherein each collar is in the form of an annulus.

20. The method according to claim 18, wherein each collar is located on the rope in the form of complementary tube sections of substantially semicircular cross section.

21. The method according to claim 18, wherein swaging the collars results in the outer cross section thereof being polygonal.

22. The method according to claim 18, wherein swaging reduces the diameter of the rope by an amount in the range 6-8%.
